(19) United States
(12) Patent Application Publication
(10) Pub. No.: US 2007/0118562 A1
(43) Pub. Date: May 24, 2007

(54) System and methods for linking multiple events involving firearms

(76) Inventors: Rocky L. Edwards, South Pasadena, CA (US); Jon Centanni, Yorba Linda, CA (US)

Correspondence Address: WAGNER, ANDERSON & BRIGHT, LLP, 3541 OCEAN VIEW BLVD, GLENDALE, CA, 91208, US

(21) Appl. No.: 11/284,534

(22) Filed: Nov. 21, 2005

(51) Int. Cl. G06F 7/00

(52) U.S. Cl. 707/104.1

(57) ABSTRACT

Methods for linking multiple events involving firearms submit event information data and firearms information data to a system that includes a database for multiple firearms events and generate a query map that correlates data in the system database with a preselected geographical grid based upon one or more preselected matching criteria to one or more data entries for a selected event. The map is used to generate a request for a possible link analysis (e.g., a NIBIN analysis) which may be initiated by a firearms examiner and is then performed to determine if there is a link. The event information data can include a case number, a geographical location data entry, a date entry, a crime type, a weapon involved and a suspect information data field based upon input from an investigating officer while the firearms information data can include a weapon data entry (such as a weapon type and caliber) and a bullet data entry (such as a lands and grooves entry, a direction of twist entry, a lands measurement and a grooves measurement) based upon input from a person with firearms examiner training. The methodology can be used to prioritize multiple requests for a possible link analysis based upon information obtained in one or more query responses and the query response can display at least some of its information in a query map that correlates data in the system database with a preselected geographical grid.

### FIELD OF THE INVENTION

The present invention is in the field of systems and methods for linking multiple events involving firearms.

### BACKGROUND OF THE INVENTION

Present society throughout the United States, and elsewhere in certain parts of the world, has come to witness widespread firearm related incidents due to terrorist and criminal activity. For example, cities across the United States are having a serious gang activity problem and, consequently, numerous firearm related incidents. As a result, firearms units across the United States have large backlogs of firearms that need to be processed as well as evidence cartridge cases and bullets that need to processed. And, because crime labs usually have limited resources, they are stretched to the limit.

Current practices in most cities in the United States dictate reactive law enforcement. That is city resources determine how law enforcement for a community reacts to crimes in their area of jurisdiction. When a serious crime occurs (homicide, attempted homicide, etc.) police officers typically respond to the initial incident, secure the crime scene, render assistance to the victims and identify potential witnesses and suspects. Crime scene investigators (CSI) respond to document the crime scene through sketches and descriptions of the crime scene, as well as 360-degree photography of the entire scene. During serious incidents such as a homicide, kidnapping or rape, detectives are assigned to investigate the case right away. Less serious crimes and gang related crimes such as drive by shootings in which a home or car is hit or the target of the shooting was not seriously wounded are handled in a different manner. A detective is not assigned the case right away, if ever, and these cases often times fall by the wayside. This is largely due to limited resources, lack of personnel and insufficient funding. Days, months and possibly years will pass (sometimes past the statute of limitations) before these cases get followed up. There are even times when the evidence will be destroyed by the evidence room before it is ever examined. Experience teaches that the perpetrators of minor shootings incidents eventually gravitate to murder.

Forensic Firearms Examiners at about 275 sites around the United States utilize a computer system, which is part of the National Ballistic Information Network. This enables technicians to digitally enter test fire crime scene cartridge cases and bullets that are submitted by detectives and CSI. This evidence results from arrests, crime scene searches and search warrants. The main function of the NIBIN (National Integrated Ballistic Identification Network) network is to link crimes to previously unknown related crimes or crimes to previously unknown related firearms. The NIBIN system works; however, it has limitations. The system is an image-based system in which only examiners and technicians have access. No information is entered into the system which is relevant to the crime itself except date of occurrence and other basic information that is not accessible to the detectives investigating the incident.

Today's Detectives (in most cities) submit a request for firearms examinations to the crime lab for entry into NIBIN. No real prioritization of the requests exists for many crime laboratories. When a request comes in to the lab it is put in line with all of the other cases and may take months or sometimes years before any forensic work is completed. Smaller police departments do not have NIBIN systems and will never have these systems. The NIBIN computer systems are only available to large crime labs around the United States with a firearms examiner. These labs were provided the NIBIN systems through Congressional funding. Funding is not available, however, for systems to be placed in smaller police departments. Currently there are no systems available to smaller departments unless they purchase their own NIBIN system.

This state of present affairs has created a number of problems. Detectives and forensic personnel have no way of actively communicating with each other on a regular basis and important criminal intelligence is lost because of this lack of communication. There are no ways to visually track crimes as they occur in the city as they are documented by Crime Scene Investigations (CSI). Many minor cases fall through the cracks and are never requested for examination and subsequently never entered into the NIBIN system. There is insufficient prioritization of cases. Communication between the crime lab, detectives and patrol is lacking. Detectives must many times fill out a lengthy lab request in order to have the lab conduct the examination. There is no screening process for requests in most departments. Smaller departments have no NIBIN system and have no way of tracking firearm related incidents; they are at the mercy of larger labs that support the surrounding community and, subsequently, their requests are put in order with other department's requests. Larger higher producing labs which have many NIBIN hits have problems managing the information (criminal intelligence) that is gathered as a result of linking cases to each other that were not previously known to be linked; there is no central data point for information gathered as a result of NIBIN links. Reports writing of cold case links are time consuming. There is no way of screening what cases are sent to the crime lab for examination. There is no visual or class characteristic screening of bullets or cartridge cases to determine if they may be related. The NIBIN systems are too expensive for use by smaller police departments if not funded through grants and departments must have a firearms examiner to obtain a NIBIN system (IBIS—Integrated Ballistic Identification System).

Accordingly, there is a very real and long-felt need for improvement, especially since these problems affect public safety and the ability of law enforcement agencies to carry out their job. The present invention addresses all of these issues and provides solutions to the above listed problems. As such, the present invention provides a critical tool for aiding law enforcement in doing its job and, as will be discussed in the detailed description of the invention, the results can be dramatic.

It is significant to note that there are over 17,000 Police Departments in the United States and over 3100 Sheriffs Offices, most of which can benefit from the present invention. Moreover, Federal and State Agencies can also use this invention. For example, agencies such as Bureau of Land Management can use this invention to assist game wardens tracking the movements and locations of poachers. In addition, there are over 60 countries in the world that could use this invention as well. This invention can be used by any of these departments to combat firearm related crimes.

Accordingly, there is an overwhelming need for this invention and its potential is almost unlimited, especially since it can be used anywhere in world under any type of conditions. Military use of this invention is also a possibility in regions where insurgency tracking through the use of firearms and the movements of people using those firearms is important.

### SUMMARY OF THE INVENTION

The present invention is generally directed to a method for linking multiple events involving firearms by submitting event information data and firearms information data to a system database for multiple firearms events and generating a query map that correlates data in the system database with a preselected geographical grid based upon one or more preselected matching criteria to one or more data entries for a selected event.

In a first, separate group of aspects of the present invention, a query map is used to generate a request (that may automatically contain some information from the system database) for a possible link analysis (e.g., a NIBIN analysis) which may be initiated by a firearms examiner and is then performed to determine if there is a link. The event information data can include a case number, a geographical location data entry, a date entry, a crime type, a weapon involved and a suspect information data field based upon input from an investigating officer while the firearms information data can include a weapon data entry (such as a weapon type and caliber) and a bullet data entry (such as a lands and grooves entry, a direction of twist entry, a lands measurement and a grooves measurement) based upon input from a person with firearms examiner training.

In a second, separate group of aspects of the present invention, a system database is created for different events which is periodically updated with data for new events that contains applicable event information data at least partially based upon input from an investigating officer (which may at least partially be done during investigation of the new event) and applicable firearms information data at least partially based upon input from a person with firearms examiner training, a permitted user is allowed to generate a query response that correlates data from the system database based upon a chosen matching criteria that can be varied by the permitted user, a request is made for a possible link analysis of two or more unlinked events based upon information obtained from the query response and then the possible link analysis is performed to determine if there is a link. Such methodology can be used to prioritize multiple requests for a possible link analysis based upon information obtained in one or more query responses and the query response can display at least some of its information in a query map that correlates data in the system database with a preselected geographical grid.

In a third, separate group of aspects of the present invention, a system for assisting analysis and correlation of multiple events involving firearms utilizes a database for storing event information data and firearms examination information data that are correlated to a single event involving a firearm, an investigating officer input mechanism for adding applicable event information data at least partially based upon input from an investigating officer for a plurality of events to the database, a firearms examiner input mechanism for adding firearms information data at least partially based upon input from a person with firearms examiner training and a mapping component for allowing a user of the system to generate a query map that correlates data in the database with a preselected geographic grid based upon one or more preselected matching criteria and at least one data entry for a selected event. The system can also include report generating components to generate reports based at least in part upon firearms examination information in the database.

Accordingly, it is a primary object of the present invention to provide a new system and methods for linking multiple events involving firearms that will assist in the investigation of such incidents.

This and further objects and advantages will be apparent to those skilled in the art in connection with the drawings and the detailed description of the preferred embodiment set forth below.

### BRIEF DESCRIPTION OF THE DRAWINGS

FIG. 1 is a screen shot of a main menu of a computer screen that is running a preferred embodiment of a program utilizing the present invention.

FIG. 2 is a flow chart depicting the flow of data from the main menu shown in FIG. 1 wherein the flow is tied to selection of the first menu option.

FIGS. 3-5 are flow charts depicting the flow of data from the main menu shown in FIG. 1 wherein the flow is tied to selection of the second through fourth menu options, respectively.

FIG. 6 is a screen shot of options accessed as page 2 from FIG. 1.

FIGS. 7-13 are flow charts depicting the flow of data from the menu shown in FIG. 6 wherein the flow is tied to selection of the first through seventh menu options, respectively.

FIG. 7A is an illustrative sample of a report of firearms correlated incidents between specific dates.

FIG. 8A is an illustrative sample of a report of weapon type, caliber and NIBIN entry status.

FIGS. 9A and 9B are an illustrative sample of a report of bullet caliber, lands, grooves and twists.

FIGS. 10A and 10B are an illustrative sample of a report of weapon caliber and grid.

FIG. 12A is an illustrative sample of a report of all firearms correlated incidents.

FIG. 14 is a screen shot of options accessed as Technical Firearms Information Input from FIG. 1.

FIG. 15 is a screen shot of options accessed from the first option of FIG. 14.

FIGS. 16-21 are flow charts depicting the flow of data from the menu shown in FIG. 15 wherein the flow is tied to selection of the first through sixth menu options, respectively.

FIGS. 23-26 are flow charts depicting the flow of data from the menu shown in FIG. 14 wherein the flow is tied to selection of the second through seventh menu options, respectively.

FIG. 22A is an illustrative sample of a firearms analyzed evidence NIBIN entry report.

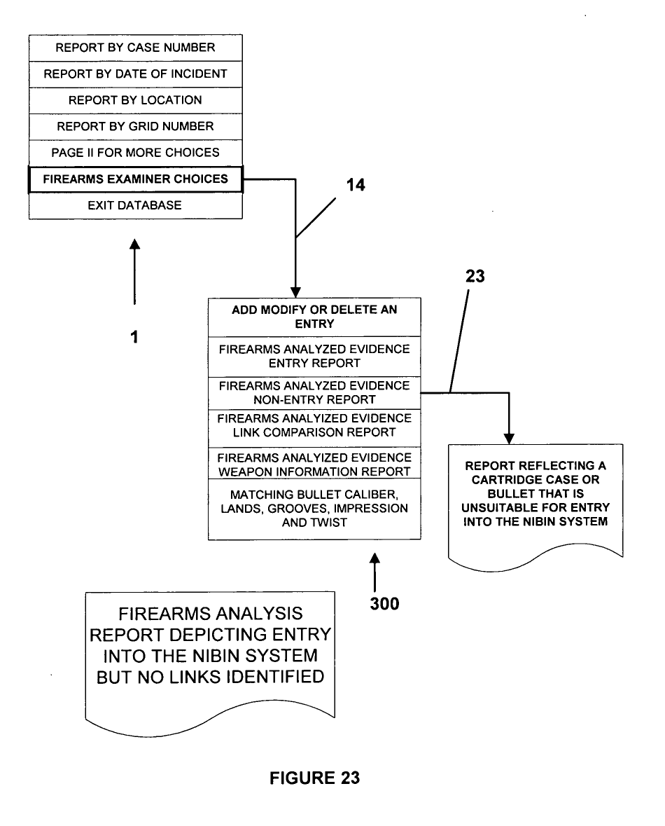

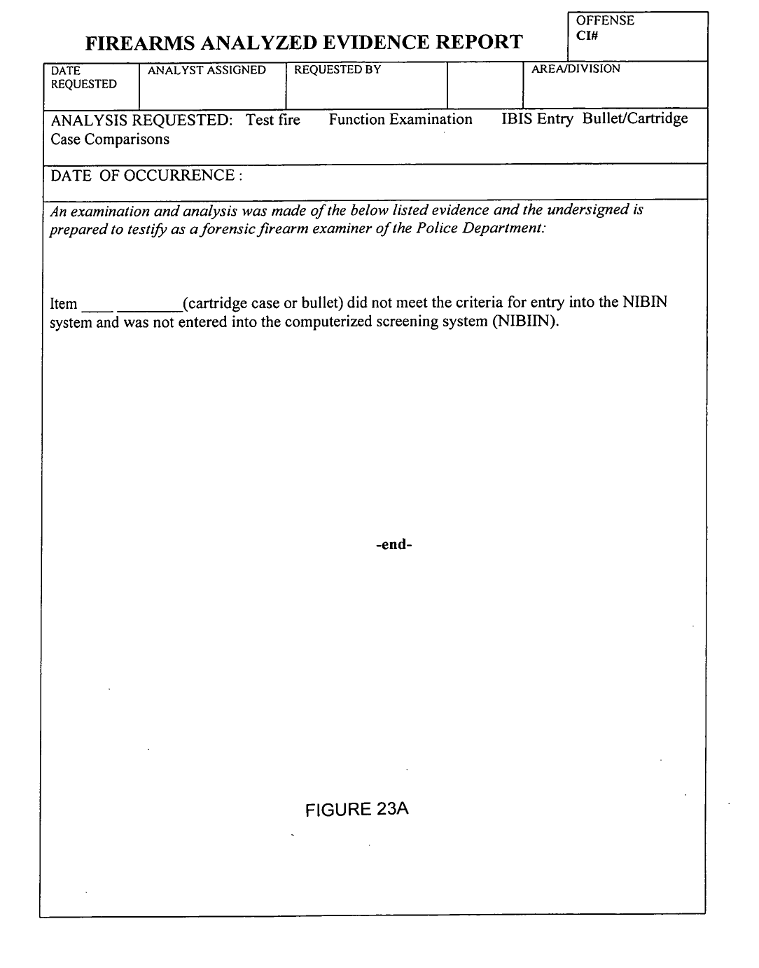

FIG. 23A is an illustrative sample of a firearms analyzed evidence non-NIBIN entry report.

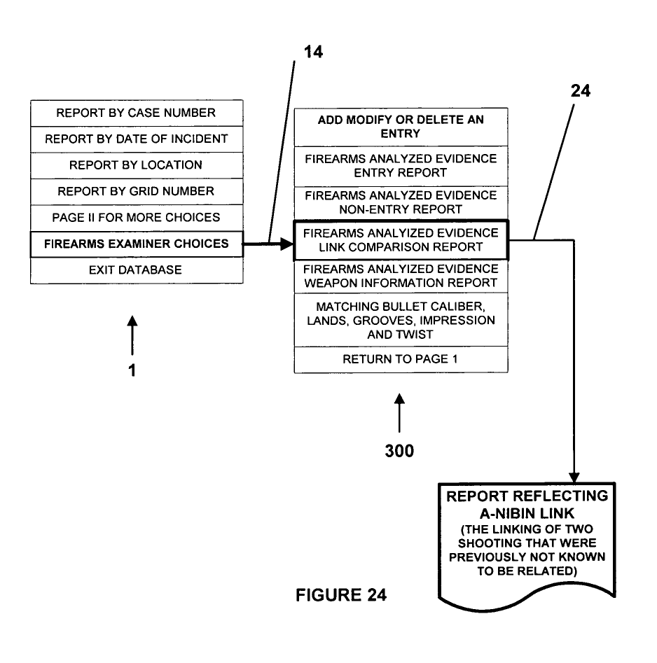

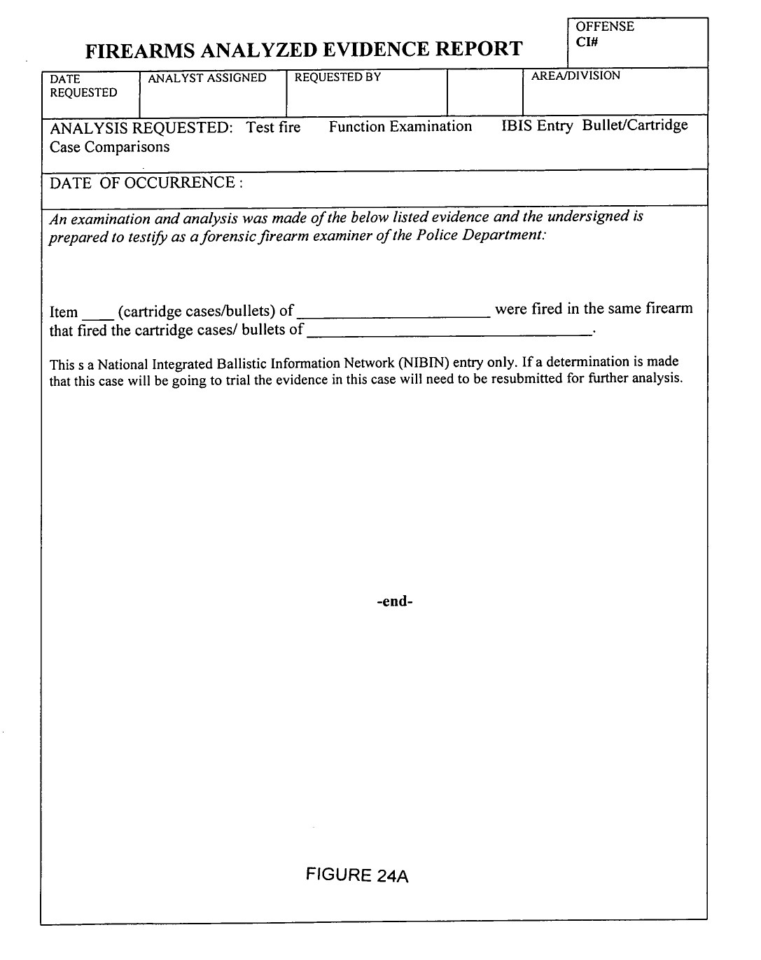

FIG. 24A is an illustrative sample of a firearms analyzed evidence link comparison report.

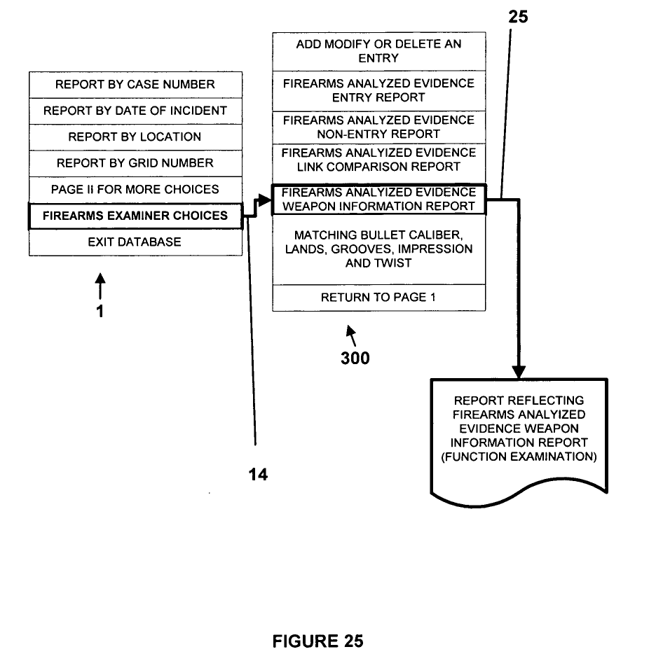

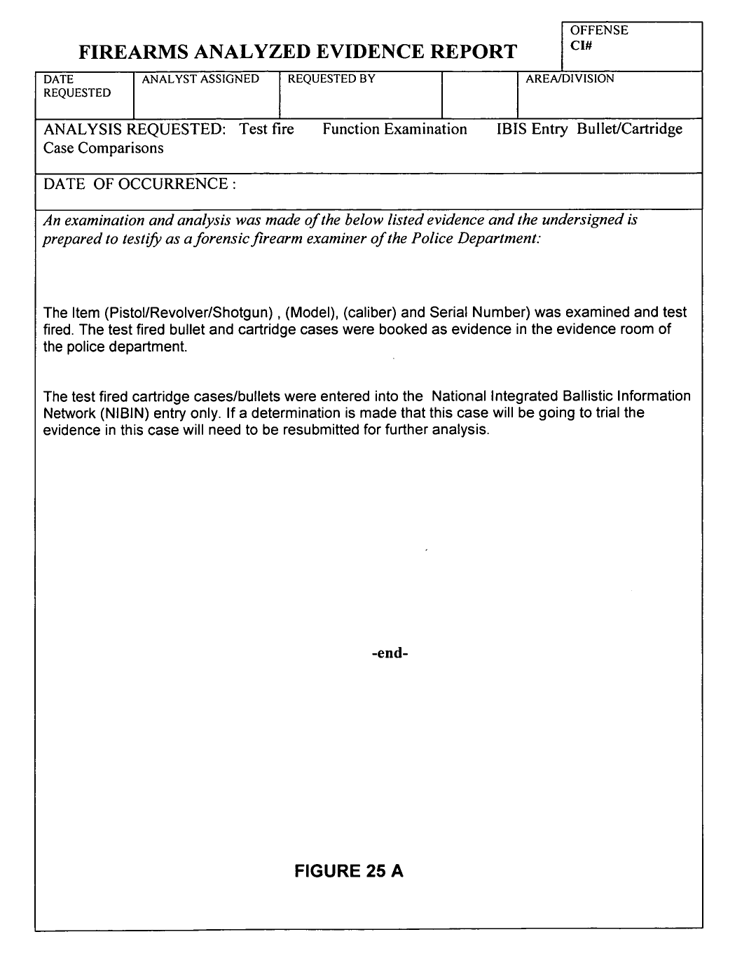

FIG. 25A is an illustrative sample of a firearms analyzed evidence weapon report.

FIG. 28 is an example of an interactive query map generated from a search result of the system of the invention.

### DETAILED DESCRIPTION OF THE INVENTION

The present invention provides a system and methods for increasing the efficiency of law enforcement agencies through targeted prioritization of investigating links related to firearms evidence.

Throughout this application, certain terms are given their normal meaning in the law enforcement community involved in investigating firearm related incidents. For ease of reference and for those not familiar with such terminology, the following glossary of a few common terms should prove helpful:
Class characteristics are those characteristics that are determined by the manufacturer before the manufacturing of the firearm such as caliber, number of lands & grooves, and measurements of the lands & grooves.
NIBIN—National Integrated Ballistic Identification System
Cold case links—Criminal incidents not previously known to be related are linked to each other.
Cartridge—A unit of ammunition consisting of a cartridge case, bullet, gunpowder and a primer.
Cartridge case—A brass cup that contains the primer, gunpowder and bullet.

An especially preferred system in accordance with the present invention has a combined three-fold system that utilizes a combined database, mapping process and imaging capabilities.

The mapping portion (1) of the system is used to indicate all firearm related incidents as they occur on a daily basis. The map uses different symbols and icons that reflect the type of evidence (i.e., firearms seized, cartridge cases and bullets recovered). The map also reflects the case number related to the incident, the caliber of the evidence seized and the type of crime that was involved. This also reflects whether or not a case has been examined and entered into the NIBIN system by the crime lab. An icon reflects if the lab has not examined the case. When the icon is removed it reflects that the casework was completed. This gives a real time view of what is occurring in the city in regard to the hot spots of gun related activity. No matter what the priority of the incident, it is entered into the database and reflected on the map. This information is to be utilized by Detectives and Crime lab technicians to help prioritize casework based on the location of the incident and not just based upon the severity of the crime. The information is also available to patrol officers so they can review what incidents are occurring in their prospective patrol areas from the previous days, weeks or months. This helps officers know what type of crimes have occurred in their area of assignment, as well as suspect descriptions, and/or the type of firearms the crime lab and detectives are looking for that were involved in recent incidents.

The database (2) portion of the system is the brain that drives the system. Entries into the data base system involve specifics of the crime such as the case number, crime type, caliber, brief synopsis of incident, and mapping grid. A unique part of this system is the ability to visually see on a map the results of any search results from the database system. This data and mapping visualization is available to the lab technician, detective and patrol officer. For example: a detective or technician wants to see how many firearm related incidents had .45 caliber cartridge cases recovered from crime scenes. The map would then show indicators of where each of the .45 Auto shootings occurred. (For an illustrative example of how such a map might look, see FIG. 29.) It would then determine which shooting had not been entered into the NIBIN system. The firearms technician can then enter the evidence into the NIBIN system in a search for possible cold case links to other shootings.

The imaging portion (3) of the system which give both detectives and crime lab personnel the ability to see what is going on in the city, view in real time criminal gang activity using firearms, see hotspots and know the caliber of firearms being used in that area, is a tremendous asset. This enables the detective to alert patrol units as well as allows patrol officers the ability to see what type of firearms they are looking for and the areas where the activity is occurring. This program gives the detectives a proactive approach to fighting crime and an overall view of the activity through the interactive database thus allowing community orientated policing that is not just reactive. This affords officers the ability to view firearms related incidents and determine where they are a problem for that particular state, county, city and/or neighborhood.

By using this system crime lab personnel can review the type of incidents occurring on the streets and determine if minor cases which are normally not requested by the detectives right away should be pulled from the evidence room and entered into the NIBIN system. This promotes a more interactive communication between the crime lab, detectives and patrol because they have access to the same system at the same time.

Larger higher producing labs which have many NIBIN hits result in detectives having problems managing the information (criminal intelligence) that is gathered as a result of linking cases to each other that were not previously known to be linked.

Success with the NIBIN system results in a large amount of data that is basically unmanageable from a high producing laboratory. Detectives' workloads are tremendous to begin with. Adding the links information will just add to the burden of managing the data. However, the present invention provides a central storing house for all of this information and data. The links of different cases through firearms incidents are recorded in the database. By using the program detectives have an easy way of getting necessary information regarding crime related incidents that they are investigating.

The present invention is also a time saving tool because it cuts down on time consuming report writing by examiners related to NIBIN entries and hits by enabling automatic report writing for the firearms examiners. This cuts down on the time used for writing of reports pertaining to NIBIN links. Moreover, this system is easily adapted for any format used by any department for recording links between firearms related incidents.

Another advantage of the present invention is that it provides a solution to the problem of there not being a way to effectively screen what cases are sent to the crime lab for examination. The present invention solves this problem by providing database capabilities as well as visual acuity by showing indicators of which cases have been sent to the lab for examination, entry into NIBIN and those that have not. FIG. 28 shows how icons on the mapping portion of this program depict those cases sent to the lab for examination, those completed and those cases which have not yet been submitted. When a case has been completed the indicator for that incident showing that the case has been sent to the lab for examination is subsequently turned off. The results are then sent to the department. This icon can be changed or removed by Lab personnel once the examination has been completed.

Another advantage of the present invention is that it provides for the screening of class characteristics such as whether a cartridge case has a circular firing pin, elliptical firing pin, arched, parallel, cross hatch, smooth or granular breech faces. All of these are important screening characteristics that can be determined by a firearms technician (officer trained in class characteristic screening) prior to lab request submission, but for which there is presently no real way to use such data as an effective screening tool. For example: Three shootings occur in a neighborhood all involving 9 mm Luger in caliber firearms. The cartridge cases recovered from each of the three crime scenes disclose that two of the shootings cartridge cases have circular firing pins with parallel breech faces. The other cartridge case (from the third case) has an elliptical firing pin (indicative of being shot in a Glock or Smith & Wesson Sigma). The technician submits the two cartridge cases to the lab for examination indicating that the two cases have class characteristic similarities and should be prioritized by the lab for entry into the NIB IN system, while the third does not.

Further, the database portion of this program allows bullets to be entered so that class characteristic screening can be accomplished. Screening of bullets includes caliber, number of lands & grooves, direction of twist, as well as measurements of the lands & grooves to be sorted and screened to determine if they have the same class characteristics of other shootings. For example: Four shootings occur in a given area all involving 38/357 in caliber bullets. Two of the shootings have 5 lands & grooves with a Right twist, one has 6 lands and grooves with a right twist and another has a right twist but the bullet is so damaged the number of lands and grooves cannot be determined. The two 38/357 disclose that they have the same or very close to the same lands and groove measurements. The third bullet with the 6 lands & grooves is immediately eliminated because of the difference in the number of lands & grooves. The fourth bullet has the same measurements of lands and grooves and is then sent to the lab along with the first two bullets to see if they are related shootings. The third bullet is not submitted unless other shootings occur in the area that have 38/357 in caliber bullets with a right twist.

The present invention is also very advantageous for smaller police departments for which the NIBIN systems are too expensive. Smaller departments rely on bigger departments or sheriffs departments for their information to be entered into the NIBIN system. The present invention is more cost effective and also provides the ability to screen what is being submitted to the crime lab. This helps in turn around time for the laboratory and also helps with the ability for the department to screen evidence prior to being submitted to the lab for examination. The system of the present invention can be adapted for use in any police department around the nation and can be used in conjunction to enhance the capabilities of the NIBIN system. Firearms examiners are not abundant and are expensive to train. With this system police personnel can be trained to do information entry into this system, class characteristic screening and determine what needs to be sent to the lab as a priority, which is a huge improvement compared to current best practices of such departments that have no effective way of screening and prioritizing such requests.

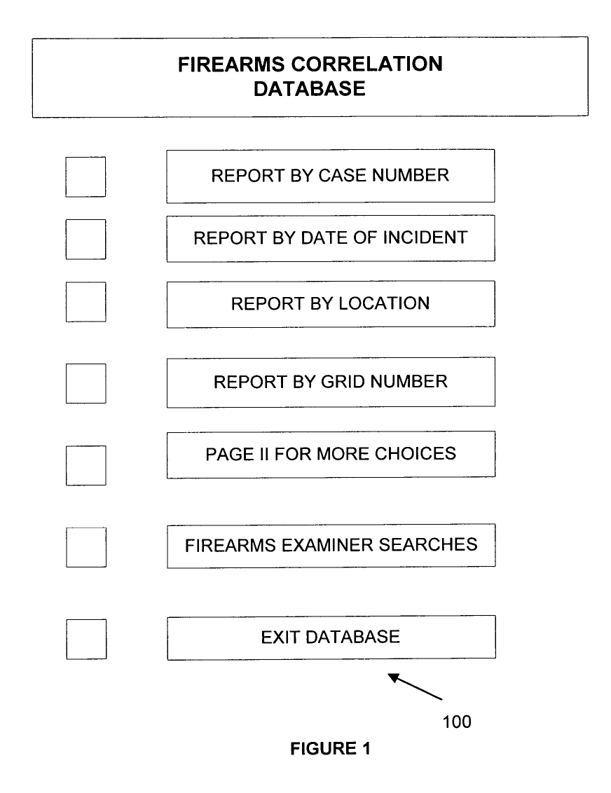

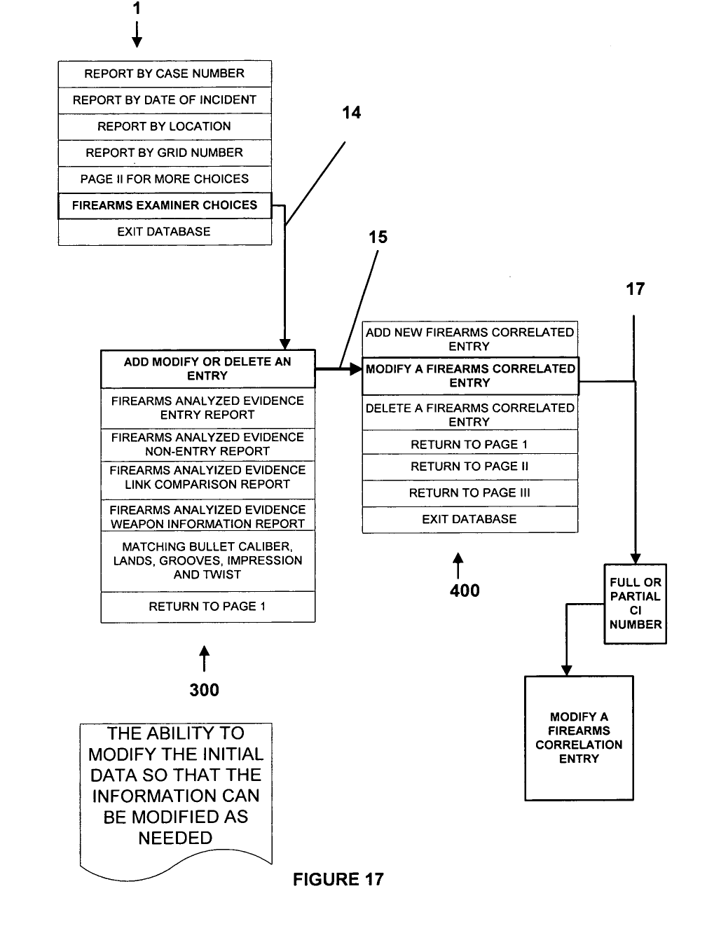

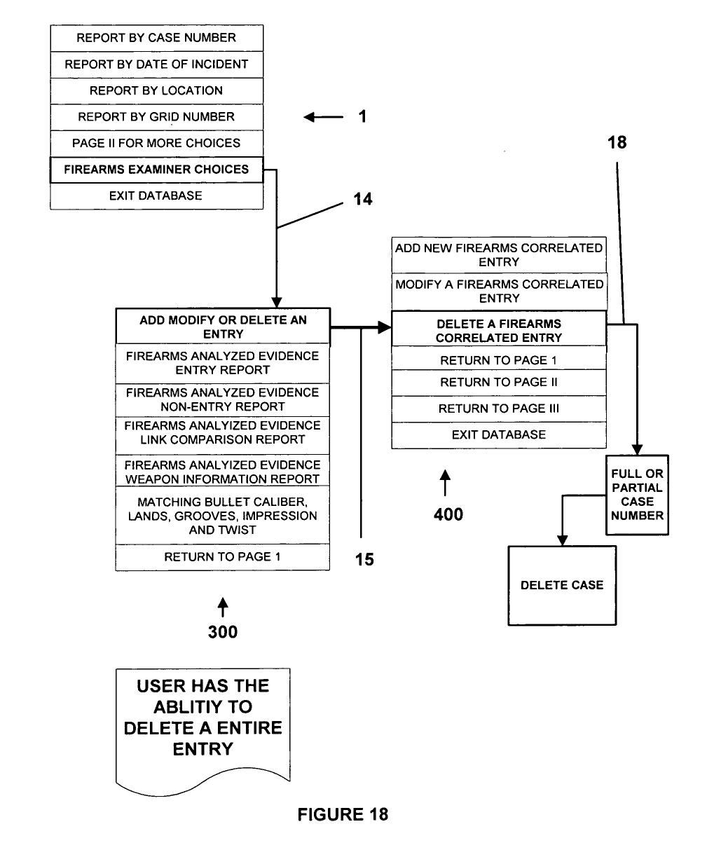

The present invention will now be described in even greater detail by reference to a preferred embodiment of a system of the present invention that is based, in part, upon an experimental prototype system that has actually been used to prove and test the concept of the present invention in a real setting. Significantly, the prototype, which does not have the advanced mapping and imaging aspects of the present invention fully implemented, is setting national records in the number of cold case links. The cold case hits using this system have resulted in increases between 300-600%. FIGS. 1-28, which will be described in greater detail below, provide a roadmap of this prototype system currently being tested, including certain refinements that have recently been made to enhance its performance. However, the following description is not meant to be limiting of the scope of the present invention, but, instead, to be illustrative of how the concepts already described can effectively be put into practice. Thus, as already noted, it is expected that a fully deployed version of the present invention will have enhanced imagining and mapping capabilities, and the report writing functions will be keyed to specific reporting needs. Also, it is anticipated that such a system will include user friendly tutorials specifically directed to targeted entries to aid in its successful implementation, especially for law enforcement agencies that do not have a trained firearms examiner.

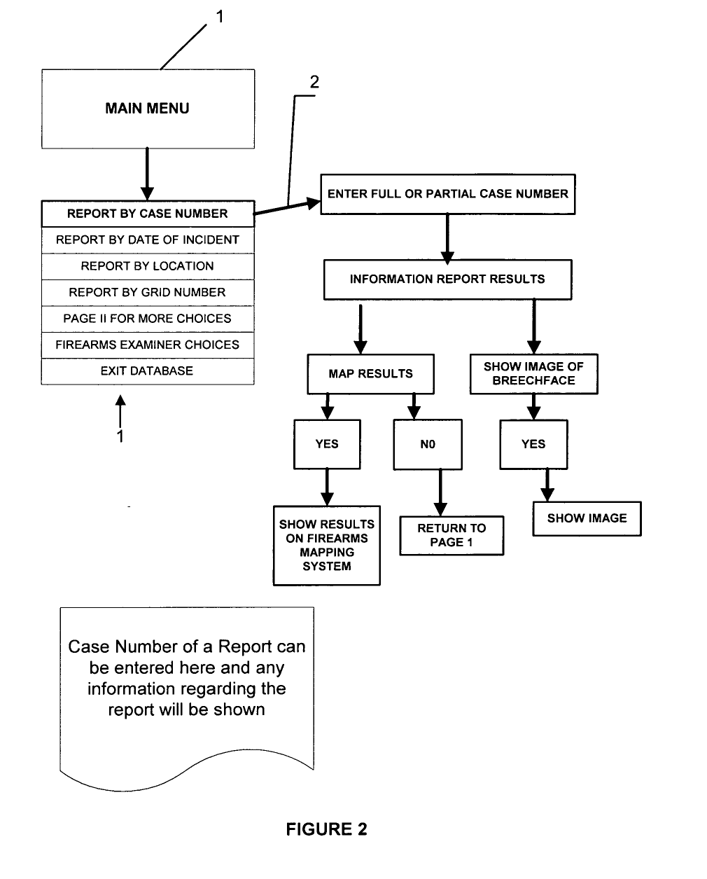

A computer network or a single computer, such as a desk top or lap top, is outfitted with a program that, once it has properly been opened (which may require a password) begins with an initial opening home page 100 (shown as FIG. 1) that is geared toward generating reports useful to many different types of law enforcement personnel. The main menu 1 (see FIG. 2) found in home page 100 allows data to be searched for information by a number of different criteria so as to create a wealth of choices which gives law enforcement officers a variety of ways to search for related information depending upon what is known for a given incident, and multiple searches may be performed quickly and efficiently and combined into a single composite report derived from multiple searches (not shown).

As shown in FIG. 2, Step 2 allows a user to display information about a case once its full or partial case number is entered and the user can either choose to map such results or show an image of the cartridge case for the case (if it exists). The partial case number entry can allow searching of the portion of the number which is known, thus simplifying the process and saving time when the whole case number is not remembered. Thus, for this option, the program allows the user to enter the case number of the report and obtain any information regarding that case that was previously entered and the case can be shown on the linked mapping system if the user wishes to do so. While the image of the cartridge case cannot, by itself, be used to establish a link, it can help narrow potential links when images of the cartridge case are also present in other cases that might be potentially linked to a chosen case.

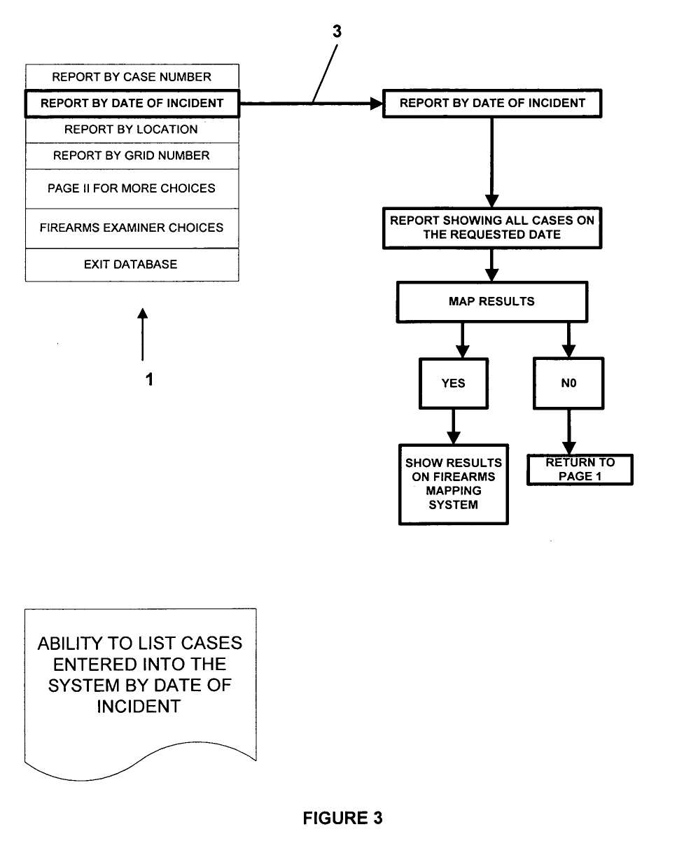

As shown in FIG. 3, Step 3 allows a user to search for cases by a specific date, and then to map the results of the search.

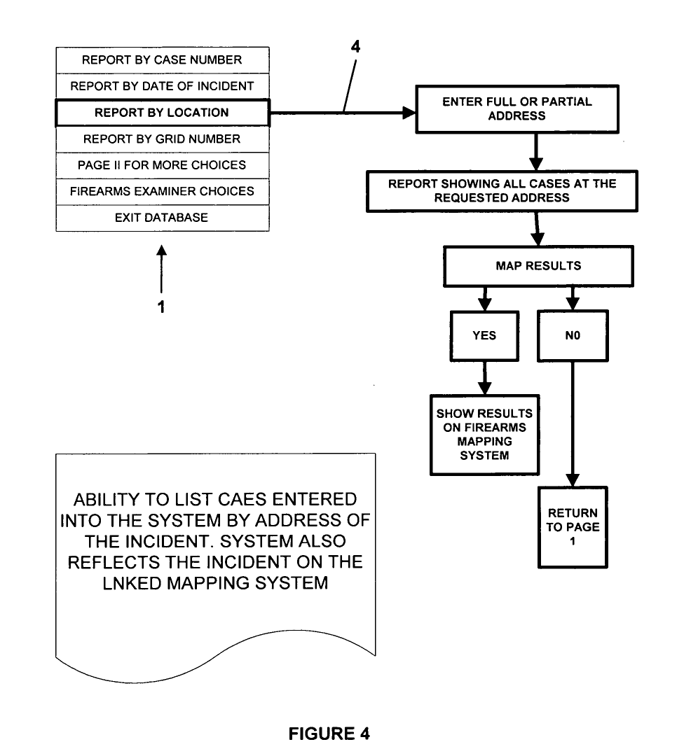

As shown in FIG. 4, Step 4 allows a user to list cases entered into the system by address of the incident and to map other incidents at the same location.

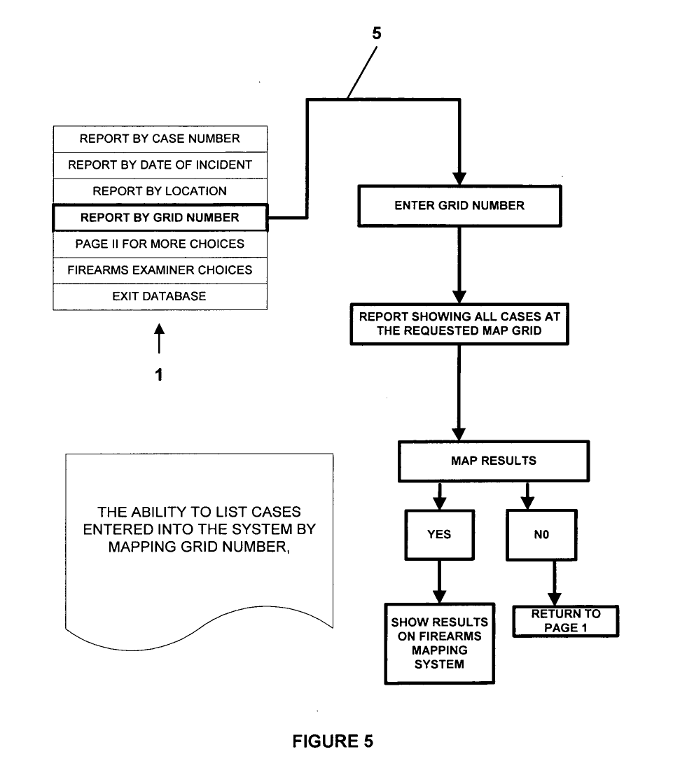

As shown in FIG. 5, Step 5 allows a user to enter a grid number from a map and obtain a report showing all cases at the requested map grid, and then these incidents can be mapped. This step can also be designed to allow for multiple map grids to be entered in a single query, or for additional map grids to be added to the results of an initial query.

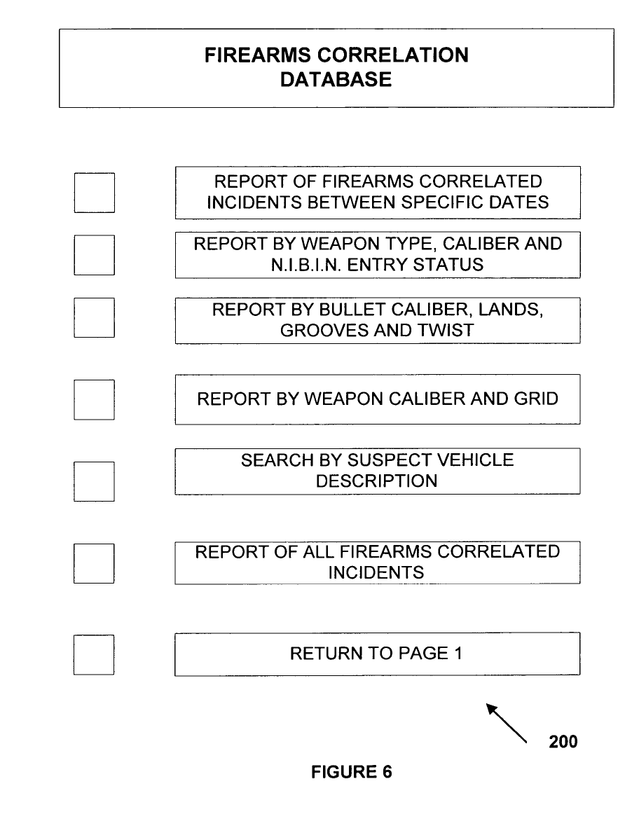

From home page 100 a user can also go to additional menu page II, 201, by step 6 (a screen shot of page II, 200, is shown in FIG. 6) to access additional search possibilities.

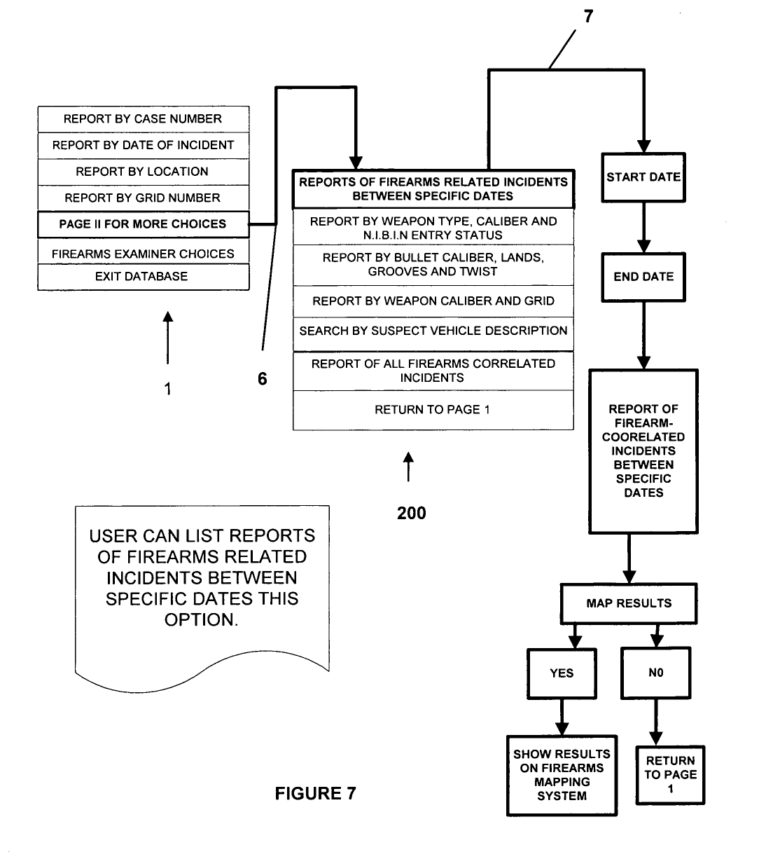

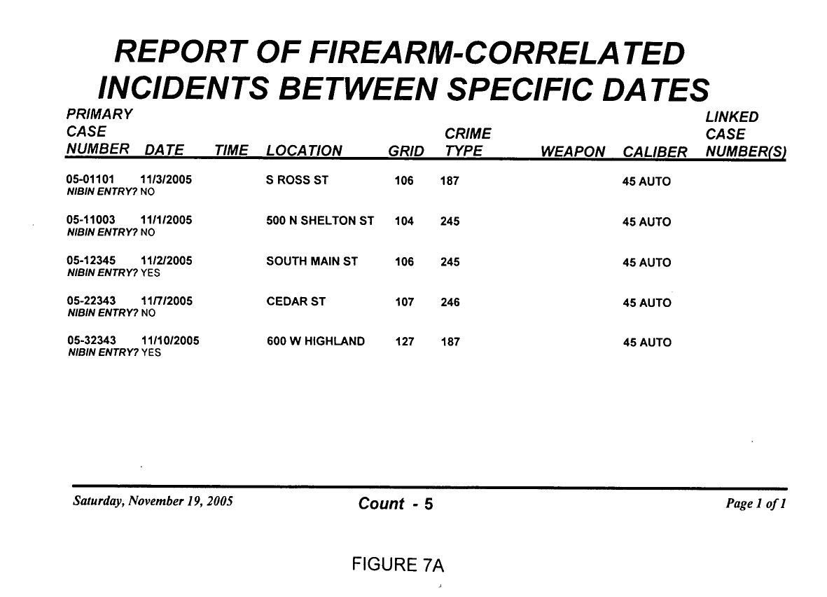

As shown in FIG. 7, Step 7 allows a user to obtain reports of firearms related incidents between specific dates by entering start and end dates for the search and then map such results. FIG. 7A is an illustrative sample of a report of firearms correlated incidents between specific dates. This type of report can be especially useful for narrowing down dates when a witness or informant cannot recall an exact date, but is aware of a general time frame, or when a detective wants to review shooting incidents a particular time frame such as, for example, when the detective may not have been working or reviewing information.

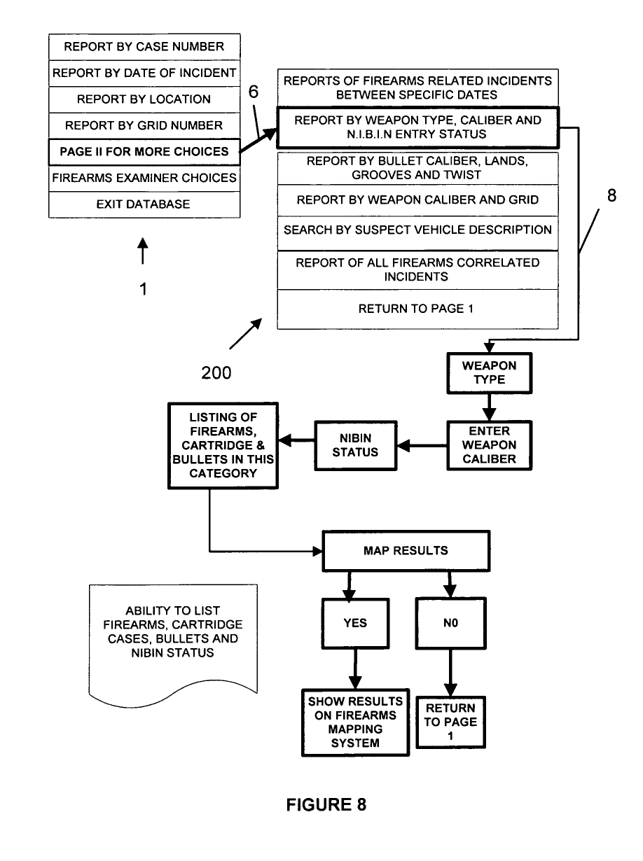

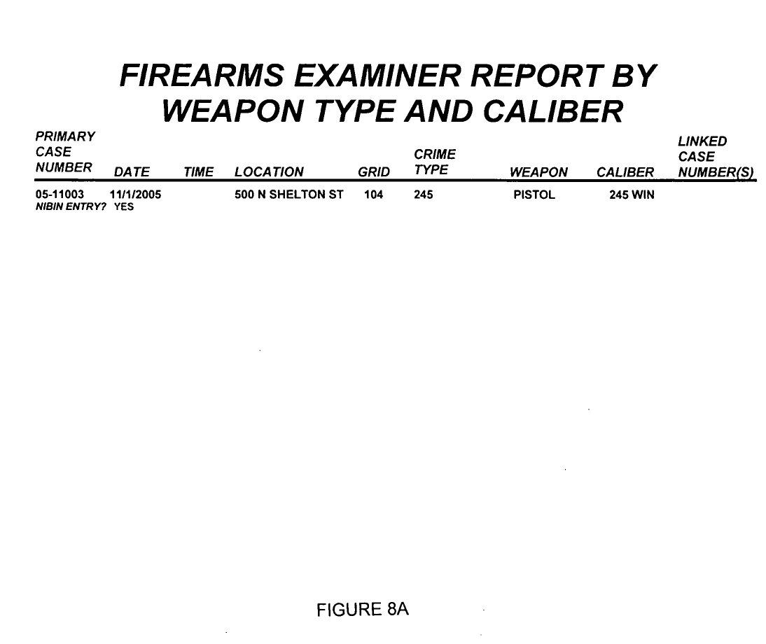

As shown in FIG. 8, Step 8 allows a user to obtain reports based upon weapon type, caliber and NIBIN entry status, and then map such results. FIG. 8A is an illustrative sample of a report of weapon type, caliber and NIBIN entry status. This type of report can be especially useful for visually prioritizing shooting incidents where evidence recovered (i.e., bullets and cartridge cases) are of the same caliber as the weapon recovered from the suspect or insurgent. This helps to prioritize what is looked at by the firearm technician, thus saving time, expediting the analysis process and providing useful investigative information to detectives and/or military personnel on the scene.

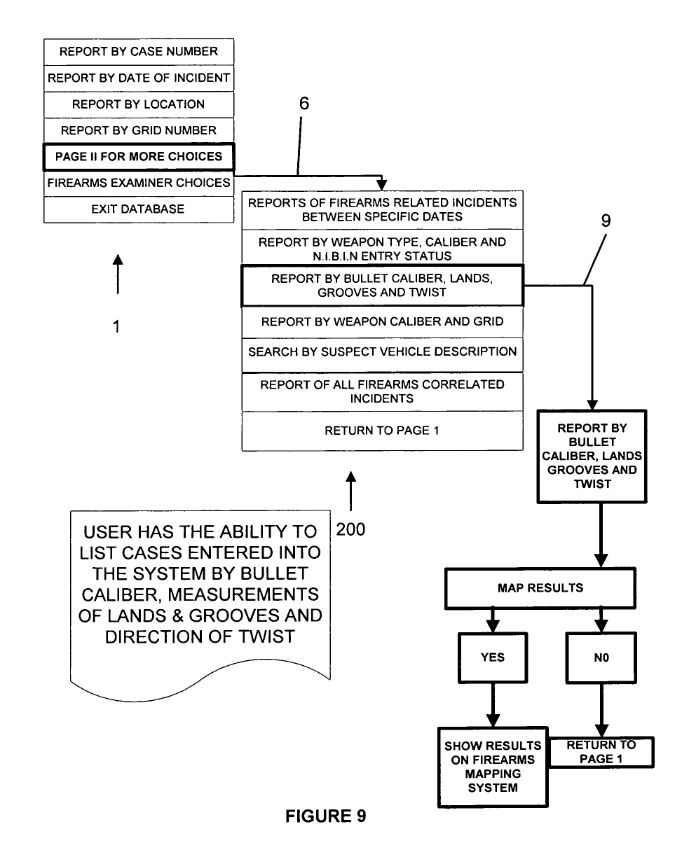

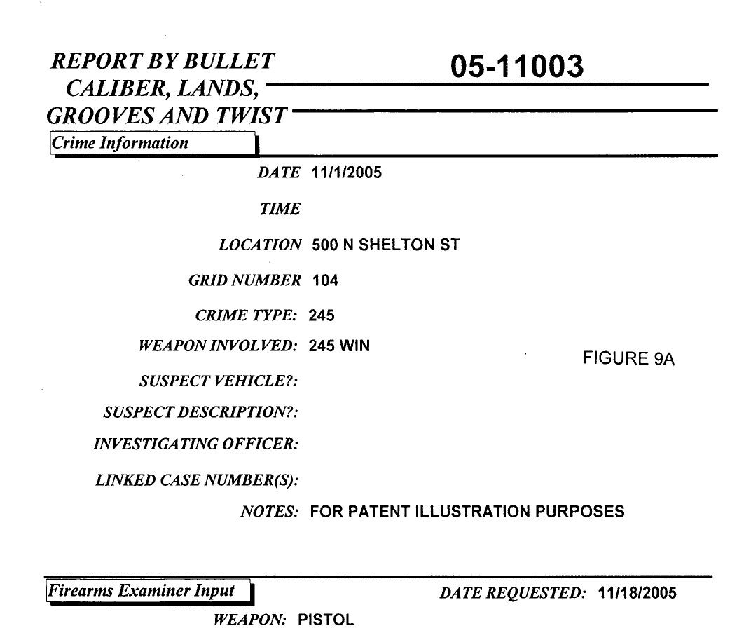

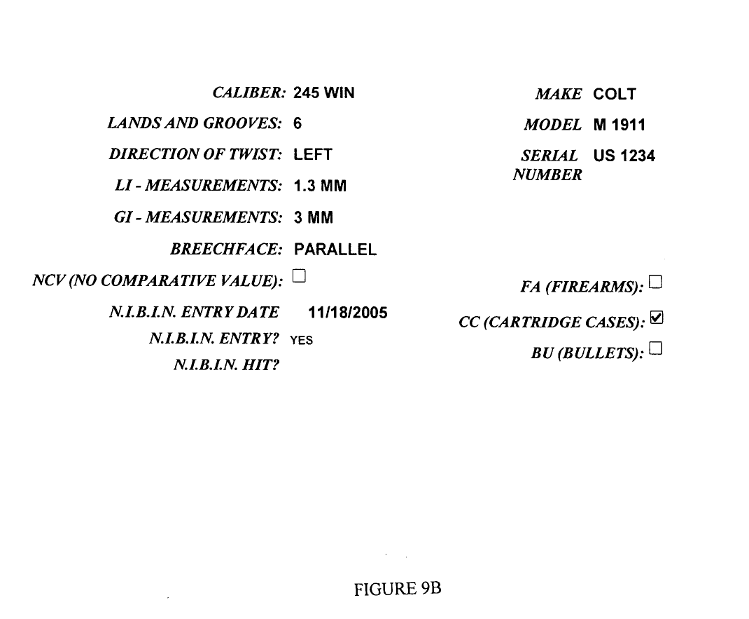

As shown in FIG. 9, Step 9 allows a user to obtain reports based upon bullet caliber, lands, grooves and twist and then map such results. FIGS. 9A and 9B are an illustrative sample of a report of bullet caliber, lands, grooves and twists. Significantly, this type of report is extremely valuable in prioritizing requests for possible link requests, yet this is the type of data that might otherwise be lost in a “jungle” of data and something that presently does not receive sufficient attention from law enforcement agencies because of the lack of a system such as that of the present invention.

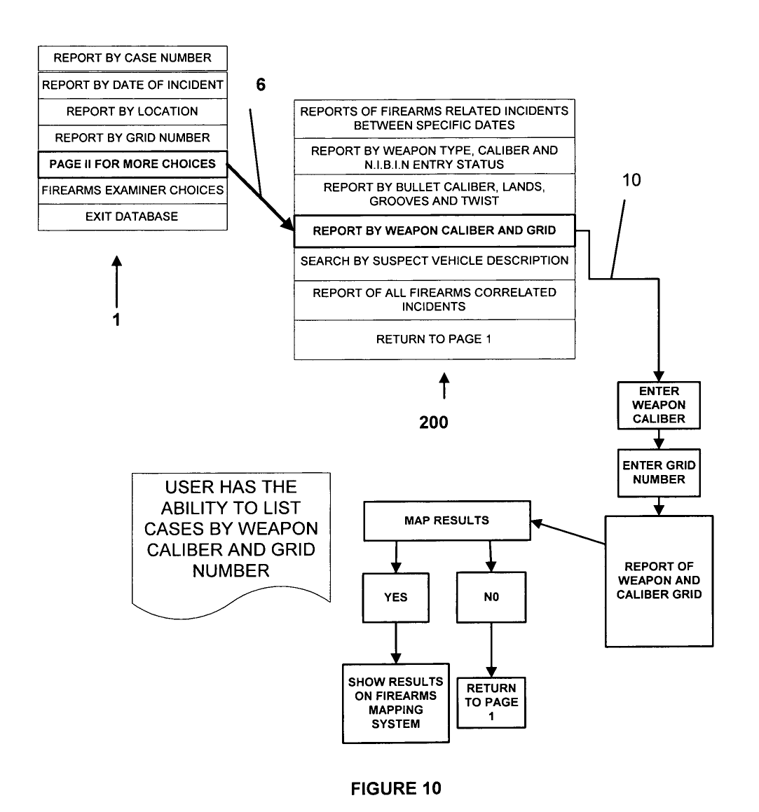

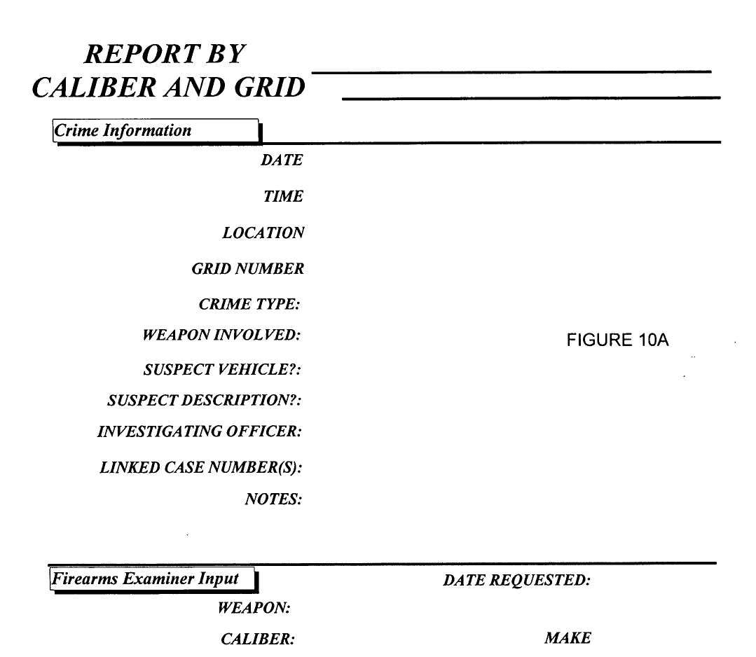

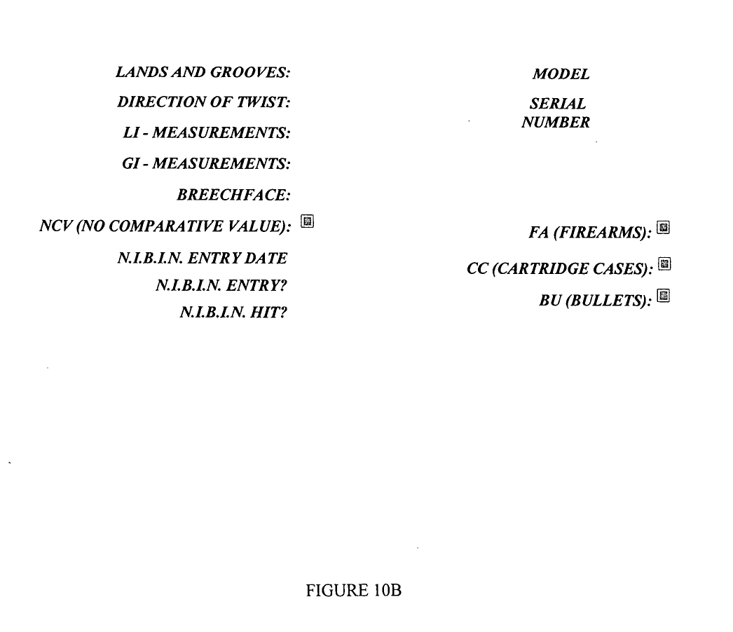

As shown in FIG. 10, Step 10 allows a user to obtain reports based upon weapon caliber and grid, and then map such results. FIGS. 10A and 10B are an illustrative sample of a report of weapon caliber and grid. This type of report can be especially useful for when a detective wants to see specific firearm related incidents for a specific mapping grid for a city.

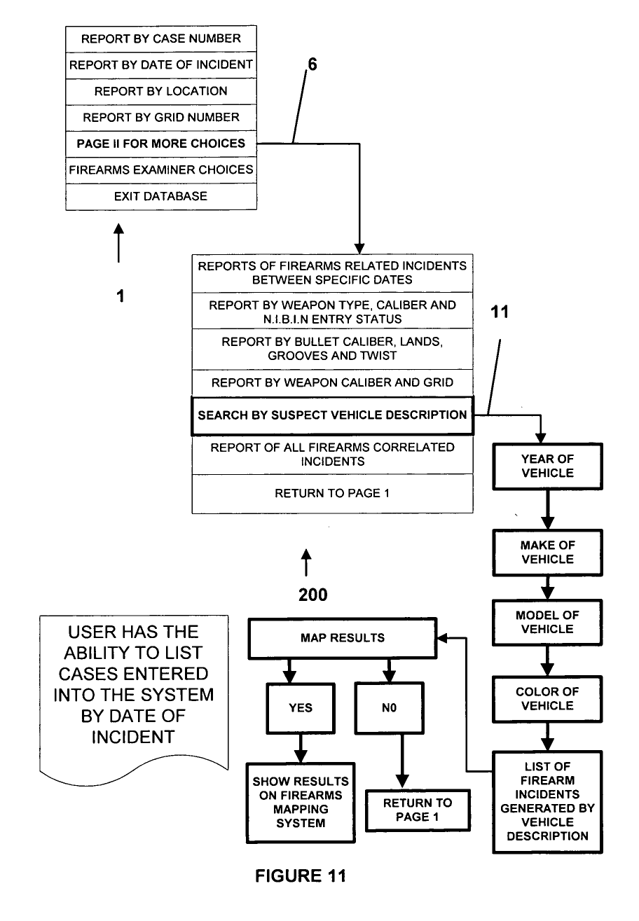

As shown in FIG. 11, Step 11 allows a user to search by suspect vehicle description and then map such results. The advantage of this step is to allow detectives to correlate data that might otherwise not be so easy to correlate, especially if the results of such a search are combined with other search results.

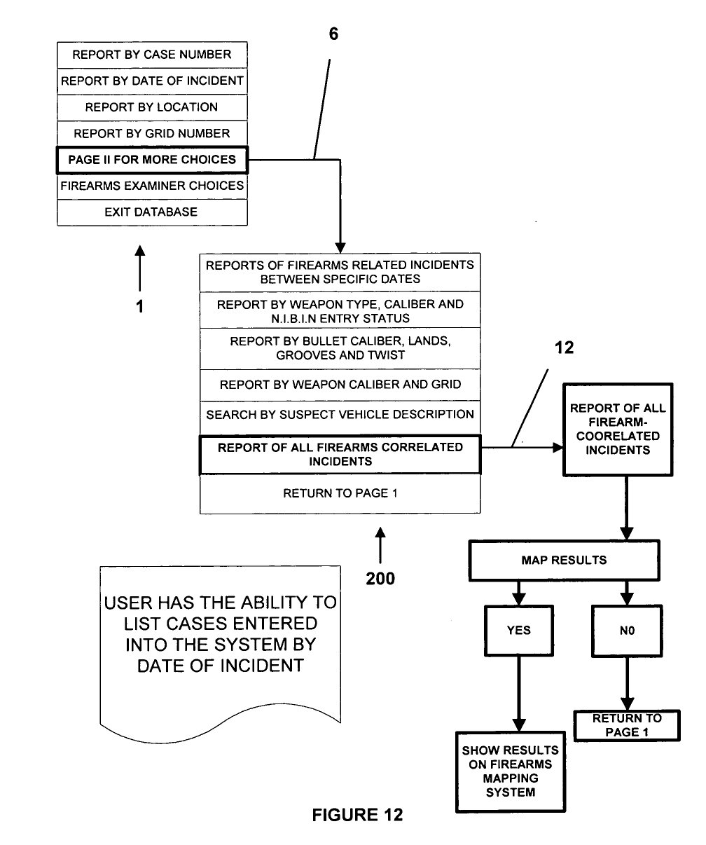

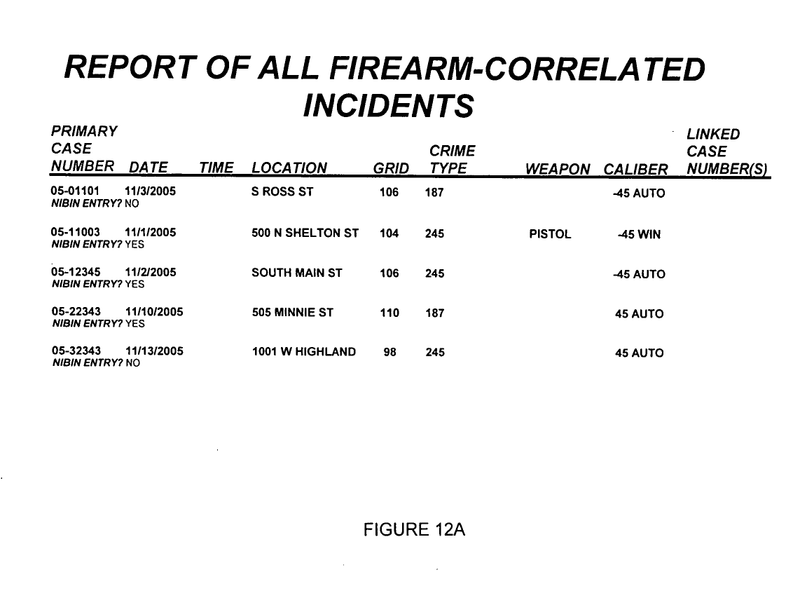

As shown in FIG. 12, Step 12 allows a user to obtain a report of all firearms correlated incidents. FIG. 12A is an illustrative sample of a report of all firearms correlated incidents. This type of report is especially useful for allowing a detective to list every piece of data that has been entered into the system database. This allows the detective to print out a hard copy of any data entered into the system.

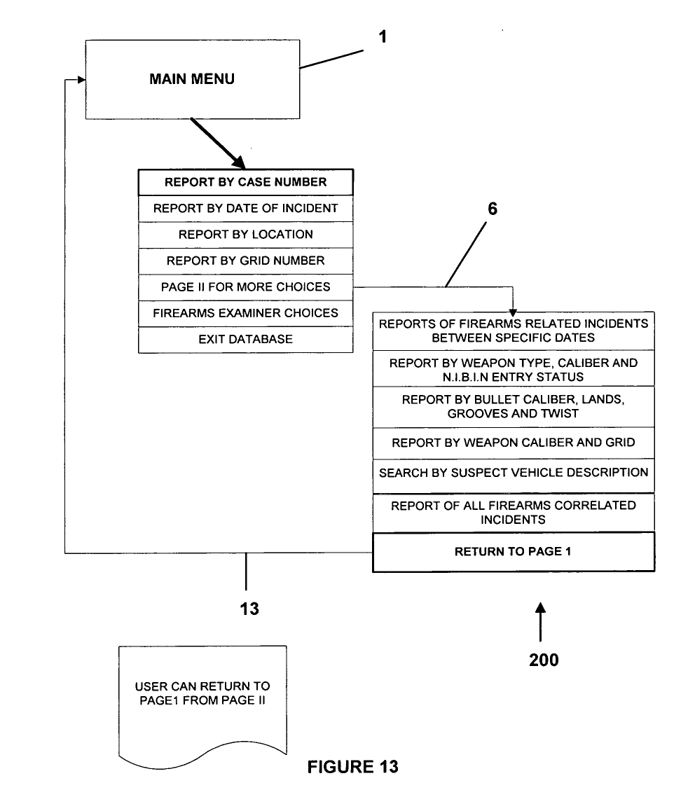

As shown in FIG. 13, Step 13 allows a user to return to home page 100.

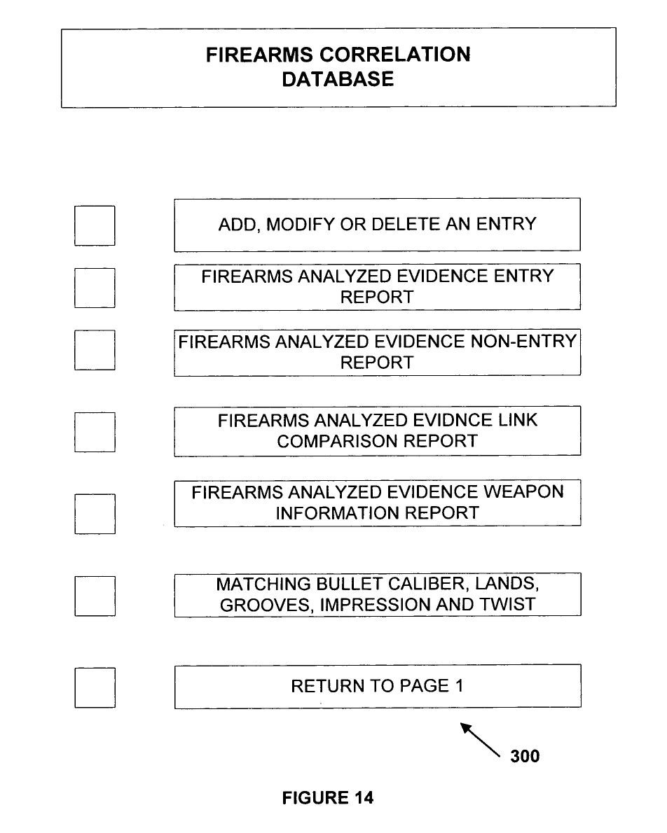

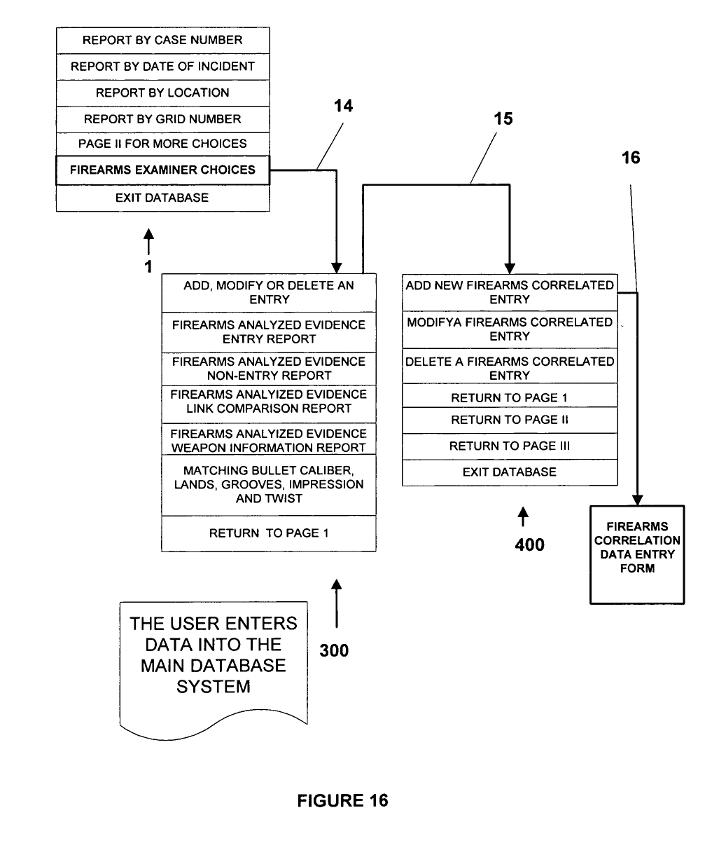

Up until now, the reports that have been accessed from home page 100 are reports that are, desirably, available to many different personnel in a given law enforcement agency, whether or not they have any firearms examiner training. In fact, it is desirable that both officers and detectives have access to the ability to easily generate such reports, and this can readily be accomplished by log-on rights in a network or a given device. However, Step 16, shown in FIG. 16 as Firearms Examiner Choices, opens a new page III (depicted in FIG. 14) which is the stepping off point for entering new data into the system, and this page and steps originating from this page should be limited to permitted users with authorized access for the action they undertake, and, ideally, back-up records should be kept of changes introduced through such access.

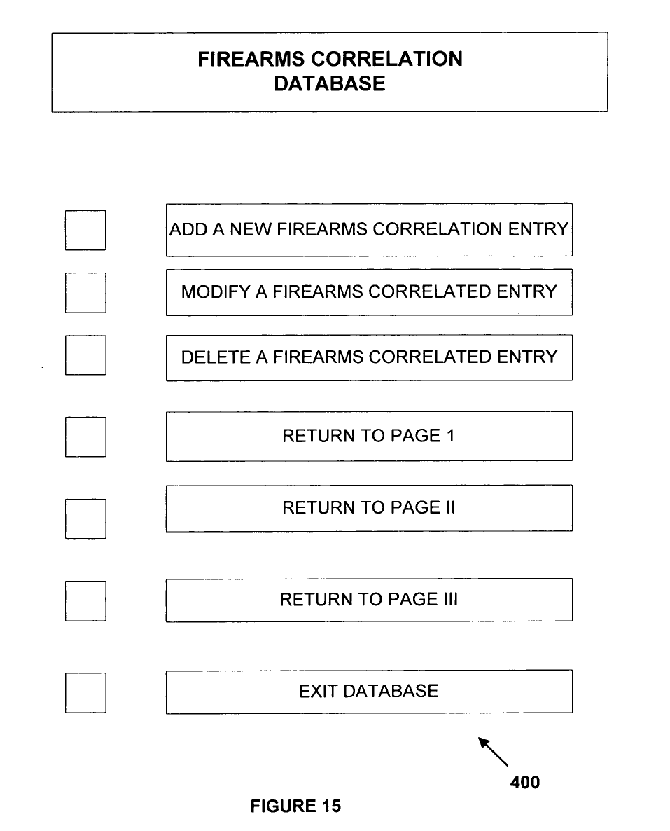

From page III, 300 (FIG. 14), once an authorized user selects step 16 to Add, Modify or Delete an Entry, the user will be taken to a new page IV, 400 (depicted in FIG. 15) from which these three actions can be taken as steps 16-18 as depicted in FIGS. 16-18, respectively. Tables 1 and 2 below list the various data fields that can be accessed by steps 16 and 17 and also provide a more detailed description of the information to be entered into these data fields.

TABLE 1
Event Information Data for Entry to the System Database

| | MORE DETAILED DESCRIPTION |
|---|---|
| CRIME INFORMATION | OF DATA FOR ENTRY |
| Primary Case Number | Case number assigned by the |
| | department on each incident |
| Linked Case Number | Case numbers of linked shootings |
| | to the primary case number |
| Date | Date of Incident |
| Time | Time of Incident |
| Location | Location of where the crime occurred |
| Grid Location | Mapping grid of where the incident |
| | occurred |
| Crime Type | Offense code |
| Weapon Caliber | Caliber of weapons pertaining to |
| | this crime |
| Suspect Vehicle Year | Year of suspect vehicle |
| Suspect Vehicle Make | Make of suspect vehicle - e.g., |
| | Toyota, Ford, Dodge, etc. |
| Suspect Vehicle Model | Model of vehicle - e.g., Camry, |
| | Civic, Silverado, etc. |
| Suspect Vehicle Color | Color of vehicle - e.g., white, |
| | black, gray, green, etc. |
| Suspect Vehicle License | Any vehicle license numbers that |
| | may be obtained from witnesses |
| Suspect Description | Description of Suspects, e.g., |
| | shaved head, white shirt etc. |
| Investigating Officer | Detective assigned to the case |
| Notes | Information concerning the crime |
| | incident, e.g., suspect shot |
| | victims sitting at a red light at the |
| | intersection of 2nd Street and Flower |

TABLE 2
Firearms Information Data for Entry to the System Database

| FIREARMS | MORE DETAILED DESCRIPTION |
|---|---|
| EXAMINER INPUT | OF DATA FOR ENTRY |
| Date Requested | Date Detectives requested the examination |
| | by Firearms Unit |
| Requested By | Person requesting the examination |
| WEAPON | |
| Weapon Type | Pistol, revolver, derringer, shotgun and rifle |
| Caliber | Caliber of weapon, e.g., .45Auto, .38 Special, |
| | .22 Long Rifle |
| Evidence Type | Cartridge cases, bullets, firearms |
| Make | Make of weapon, e.g., Glock, Ruger, Sig Sauer, |
| | LLAMA, etc. |
| Serial Number | Serial number of seized firearm |
| BULLET DATA | |
| Lands and Grooves | Number of lands and grooves in the barrel of |
| | suspect weapon, e.g., 5, 6, etc. |
| Directions of Twist | Direction the bullet is spinning when it |
| | departs the barrel of the suspect's firearm |
| LI -Measurements | Measurement of the fired bullets Land |
| | Impression |
| GI- Measurements | Measurements of the fired bullets Groove |
| | Impression |
| NCV | No Comparative Value-Bullet is too damaged- |
| | No useful information obtained |
| N.I.B.I.N. | National Integrated Ballistic Information |
| | Network |
| NIBIN Entry Date | Date evidence (cartridge case or bullet) was |
| | entered into NIBIN system |
| NIBIN Entry | Was evidence (cartridge case or bullet) |
| | entered into the NIBIN system? |
| NIBIN Hit | Was there a link between evidence (cartridge |
| | case or bullet) to other cases? |
| Verification Date | Date the link between cases was verified by |
| | the crime lab examiner |
| EVIDENCE TYPE | Type of evidence recovered from the crime scene |
| FA (Firearms) | Was a firearm recovered from the crime scene - |
| | Check mark for yes |
| CC (Cartridge Cases) | Were cartridge cases recovered from the crime |
| | scene - Check mark for yes |
| BU (Bullets) | Were bullets recovered from the crime scene - |
| | Check mark for yes |
| Pellets | Were shotgun pellets recovered from the crime |
| | scene - Check mark for yes |
| Elliptical Firing Pin | Was the firing pin impression elliptical |
| | (rectangular) in shape - Check mark for yes |
| Breech face | Class characteristics of breech face |
| | impressions on cartridge cases recovered from |
| | the crime scene e.g. - circular, parallel, |
| | arched, crosshatch, etc. |
| Firearms Technician | Person responsible for entering the data into |
| | the Firearms Correlation Data Entry Form |
| List of Possible | Based on the Land and Groove Measurements |
| Manufacturers | obtained during examination from the recovered |
| | bullet the possible make and manufacturer of |
| | firearms that were used to fire the bullets |
| | can be determined |
| Non-Linked Case | Cases that were examined and determined that |
| Comparisons | they were not related to the Case (which saves |
| | doing duplicate work later) |

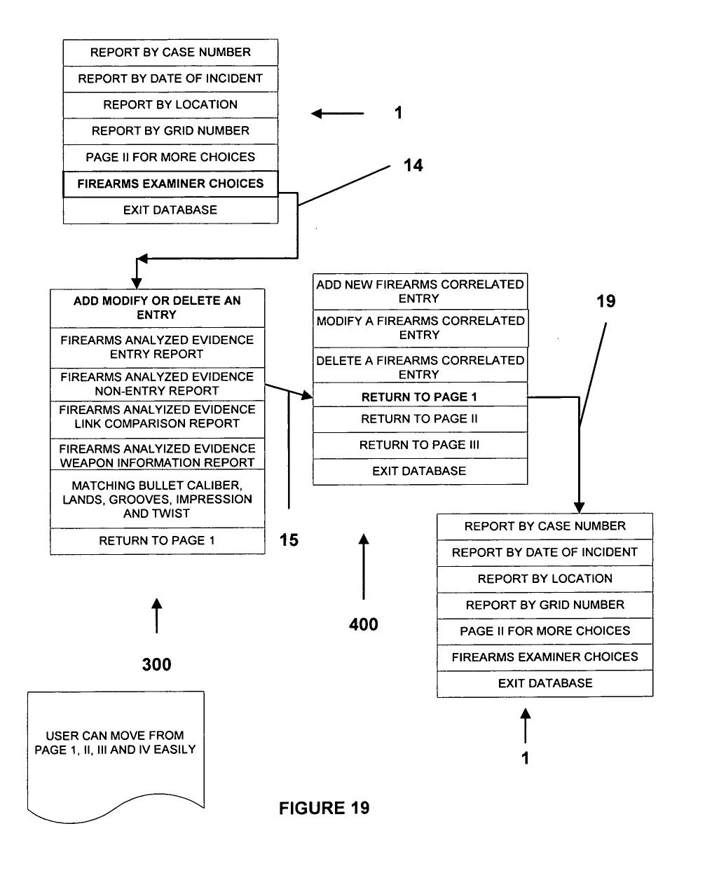

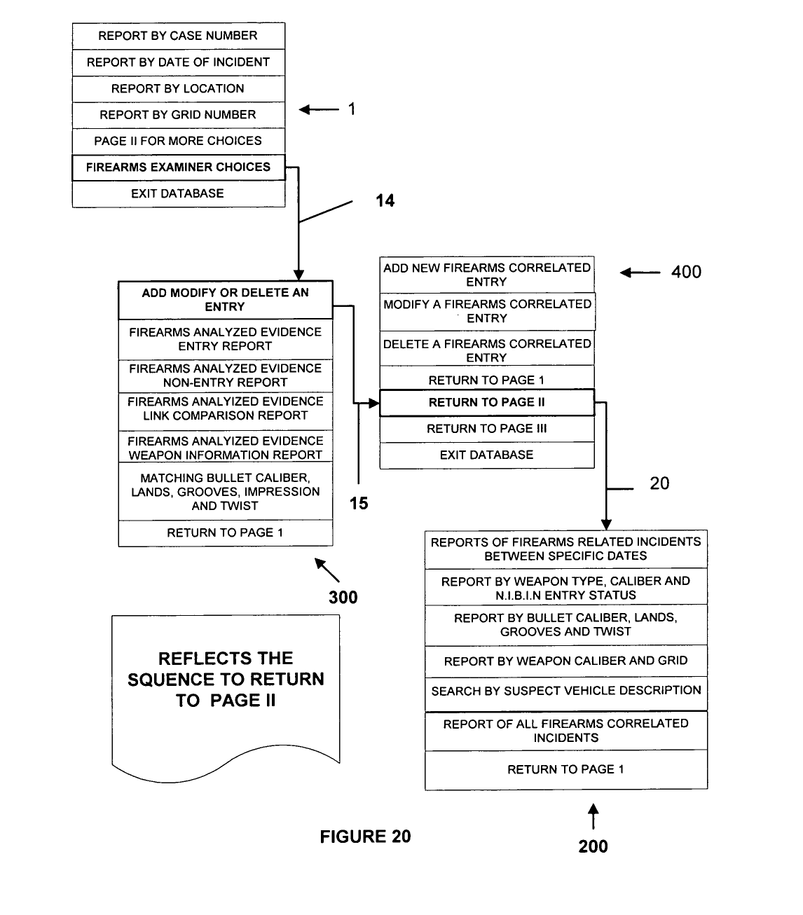

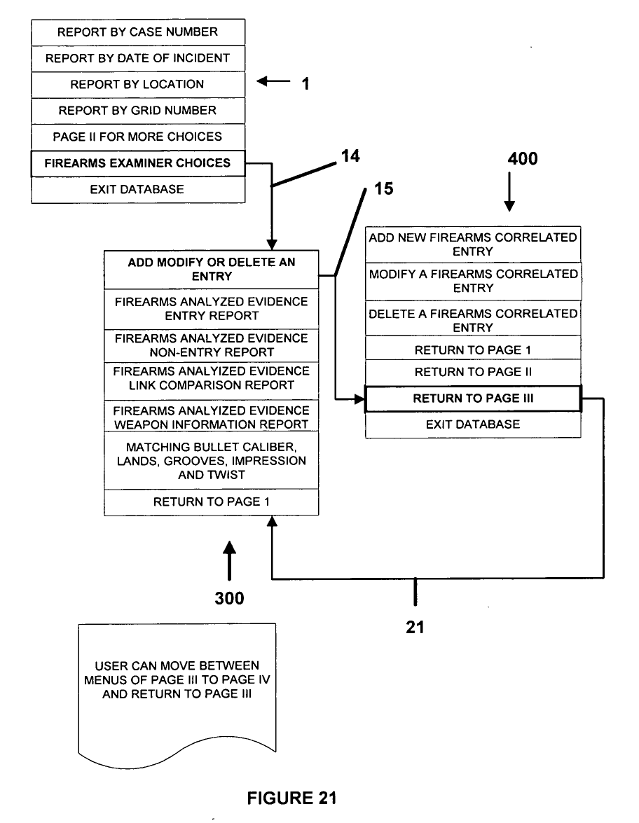

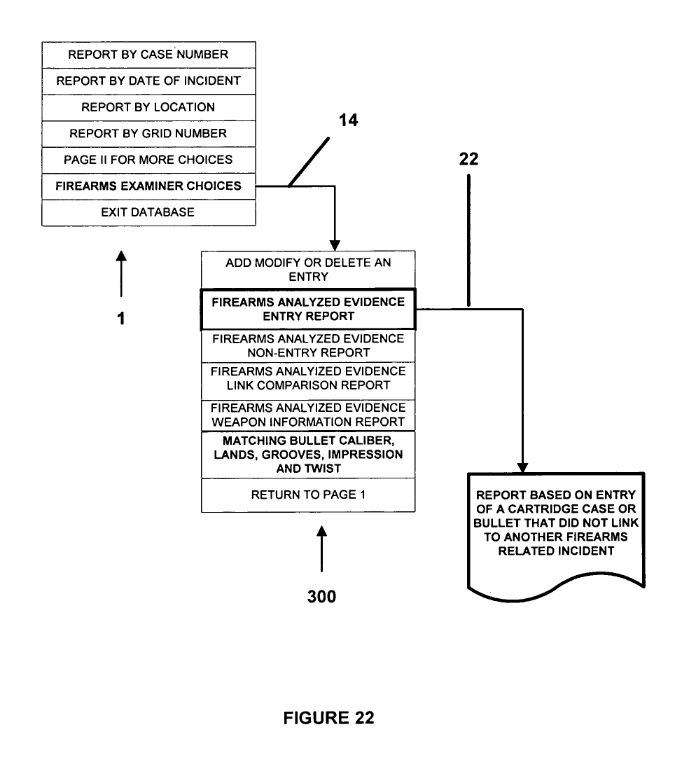

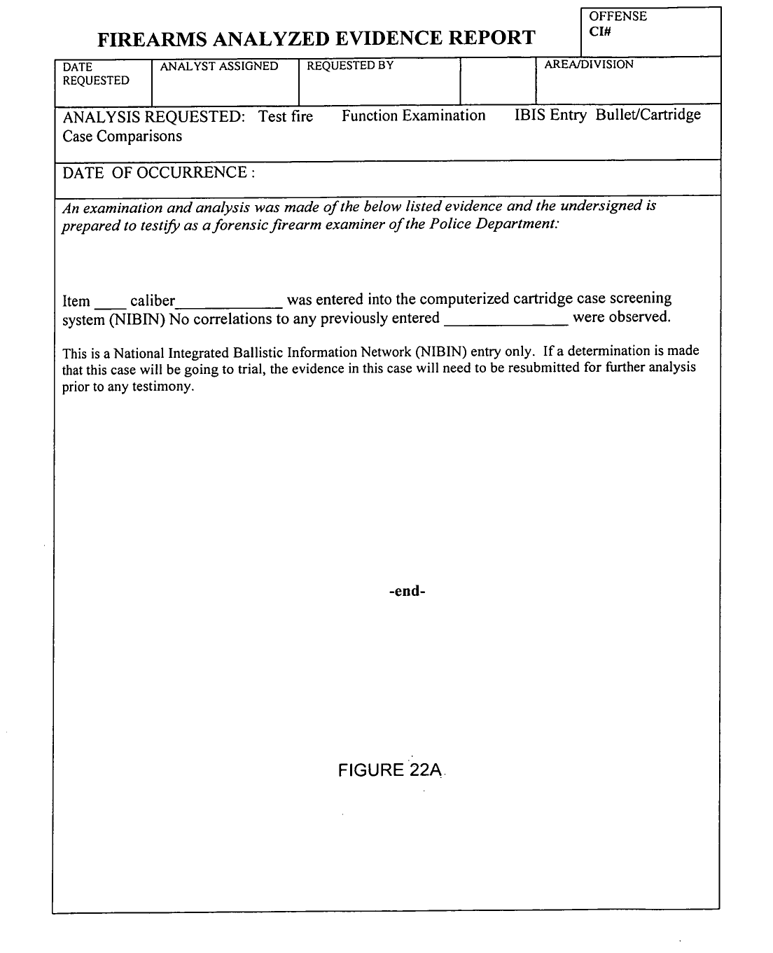

From page IV, 400 (FIG. 15), a user can return to home page 100 via step 19 (shown in FIG. 19), to page 11(200) via step 20 (shown in FIG. 20) or to page III (300) via step 21 (shown in FIG. 21).

As already noted, data dealing with event information is preferably entered by an investigating officer, or at least based upon input by an investigating officer. Thus, for example, if an officer has a connection to the computer network on which the system database is kept, event information can be entered directly by the investigating officer, potentially even in real time; however, if the investigating officer does not have such access and prepares a standard paper report, the information from such a report can be transferred to the computer network by a clerical employee with permitted access for such data entry. By contrast, data dealing with firearms information should, preferably, be entered into the computer network by somebody with firearms examiner training (such as a firearms examiner or a firearms technician), or be transferred to the computer network by a clerical employee with permitted access for such data entry based upon the input of somebody with firearms examiner training.

Going back to page III (shown as 300 in FIG. 14), several different reports can be generated by a firearms examiner or a person with firearms examiner training.

As shown in FIG. 22, step 22 will generate a firearms analyzed evidence entry report and FIG. 22A is an illustrative sample of such a report.

As shown in FIG. 23, step 23 will generate a firearms analyzed evidence non-entry report and FIG. 23A is an illustrative sample of such a report.

As shown in FIG. 24, step 24 will generate a firearms analyzed evidence link comparison report and FIG. 24A is an illustrative sample of such a report.

As shown in FIG. 25, step 25 will generate a firearms analyzed evidence weapon information report and FIG. 25A is an illustrative sample of such a report.

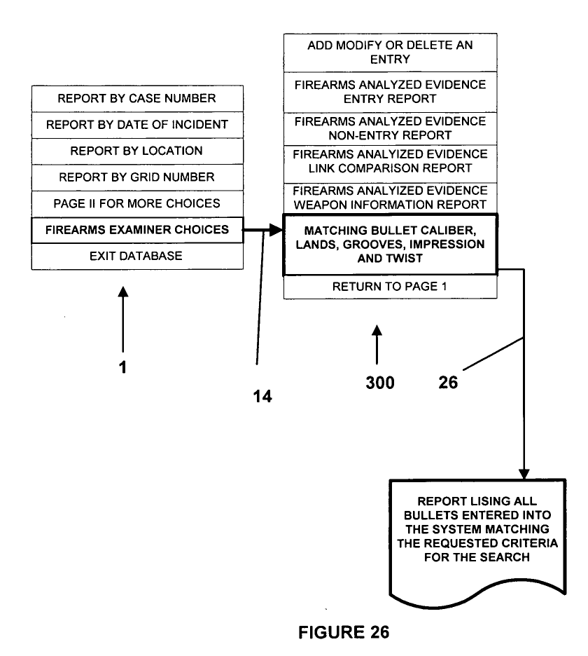

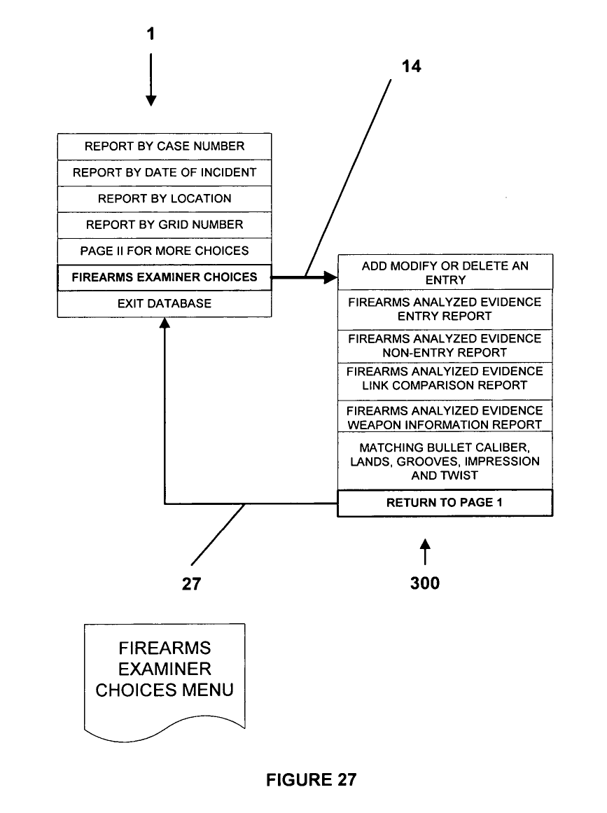

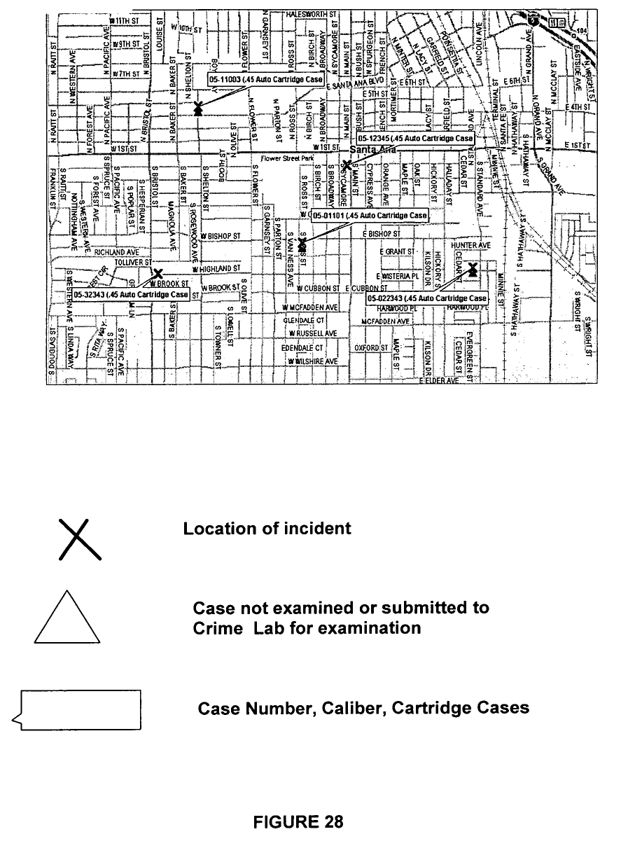

As shown in FIG. 26, step 26 will generate a matching bullet caliber, lands, grooves, impression and twist report.

Significantly, the time needed to generate any of the reports in steps 22-26 can be greatly simplified by using automatic report writing templates that pull required data needed for the report from the system database. This not only saves firearms examiner time, but also ensures accuracy of data since typographical errors are automatically eliminated.

From page III (300 shown in FIG. 14), a permitted user can return to home page 100 (FIG. 1) via step 27 as shown in FIG. 27.

FIG. 28 is a sample of a query map generated using the parameter of caliber via step 8 (see FIG. 8). The map shows a geographical mapping grid with five different incidents notes. As depicted by the map, evidence from the incidents with case numbers 05-01101, 05-11003 and 05-22343 have not yet been examined or submitted to the crime lab for examination, whereas evidence from the incidents with case numbers 05-32343 and 05-12345 have been examined or submitted to the crime lab for examination. The query map also visually identifies that all of these five incidents involved a shooting in which a .45 Auto Cartridge Case was recovered. Based upon this map, an investigating officer might pull 05-11003, 05-01101 and 05-22343 and request that they be entered into the N.I.B.I.N. system.

While the invention has been described herein with reference to a prototype embodiment of the present invention, this description has been presented by way of example only, and not to limit the scope of the invention. Additional embodiments thereof will be obvious to those skilled in the art having the benefit of this detailed description. Further modifications are also possible in alternative embodiments without departing from the inventive concept. In this regard, as technology marches forward, and both communications and computer equipment become faster, more efficient and cheaper, the present invention could easily be adapted to such changes. For example, it would be highly desirable to allow for easier collection and display of information in accordance with the present invention. Thus, GPS capabilities with a laptop connected to the mapping program and database will enable officers to see what has been occurring in their patrol area. Additional capabilities would enable officers to use devices such as a hand held that would enable them to stand at a crime scene, enter basic data regarding the scene and then send a wireless message to the program. This would enable automatic mapping with the basic information thus alerting lab personnel, supervisors and management of the crime scene. Further adaptability of the system also can cover such things as graffiti occurrences as well as managing latent print cases within the laboratory. As another example, much of the data input and data selection might be accomplished via a touch screen display, and mapping data might be displayed automatically on a visual display or a dedicated display device tasked for such a purpose.

Accordingly, it will be apparent to those skilled in the art that still further changes and modifications in the actual concepts described herein can readily be made without departing from the spirit and scope of the disclosed inventions as defined by the following claims.

What is claimed is:

1. A method for linking multiple events involving firearms, comprising the steps of:
(1) submitting data relating to a plurality of event information data to a system database for a selected firearms event;
(2) submitting data relating to a plurality of firearms information data to the system database for the selected firearms event;
(3) repeating steps (1) and (2) for a plurality of additional selected firearms events; and
(4) generating a query map that correlates data in the system database with a preselected geographical grid based upon one or more preselected matching criteria to one or more data entries for a selected event.

2. The method of claim 1, comprising the further steps of:
(5) using the query map to generate a request for a possible link analysis; and
(6) performing a possible link analysis on the request to determine if there is a link.

3. The method of claim 2, wherein the possible link analysis is based upon a NIBIN analysis.

4. The method of claim 1, wherein the plurality of event information data is comprised of a case number, a geographical location data entry and a date entry.

5. The method of claim 4, wherein the plurality of event information data is further comprised of a crime type, a weapon involved and a suspect information data field.

6. The method of claim 1, wherein the plurality of firearms information data is comprised of a weapon data entry and a bullet data entry.

7. The method of claim 6, wherein the weapon data entry is comprised of a weapon type and a caliber.

8. The method of claim 6, wherein the bullet data entry is comprised of a lands and grooves entry, a direction of twist entry, a lands measurement and a grooves measurement.

9. The method of claim 1, wherein information submitted in step 1 is based upon input from an investigating officer.

10. The method of claim 9, wherein information submitted in step 2 is based upon input from a person with firearms examiner training.

11. The method of claim 10, comprising the further steps of:
(5) using the query map to generate a request for a possible link analysis; and
(6) performing a possible link analysis on the request to determine if there is a link.

12. The method of claim 11, wherein step 5 is initiated by a firearms examiner.

13. The method of claim 11, wherein at least some of the information contained in the system database is also automatically contained in the request.

14. A method for linking multiple events involving firearms, comprising the steps of:
(1) creating a system database that contains applicable event information data and applicable firearms information data for a plurality of different events;
(2) periodically updating the system database with applicable event information data and applicable firearms information data from a new event;
(3) repeating step (2) after multiple new events occur;
(4) allowing a permitted user to, generate a query response that correlates data from the system database based upon a chosen matching criteria that can be varied by the permitted user;
(5) generating a request for a possible link analysis of two or more unlinked events based upon information obtained from the query response generated in step (4); and
(6) performing a possible link analysis on the request to determine if there is a link;
wherein the applicable event information data is at least partially based upon input from an investigating officer; and
wherein the applicable firearms information data is at least partially based upon input from a person with firearms examiner training.

15. The method of claim 14, wherein the applicable event information data includes a plurality of crime information data selected from the group comprising a primary case number, a linked case number, a date, a geographical location, a crime type, a weapon involved, an investigating officer and a suspect information data field and wherein the applicable firearms information data includes a plurality of firearms examiner input data selected from the group comprising a weapon data entry and a bullet data entry.

16. The method of claim 15, wherein the method is used to prioritize multiple requests for a possible link analysis based upon information obtained in one or more query responses.

17. The method of claim 14, wherein the query response displays at least some of its information in a query map that correlates data in the system database with a preselected geographical grid.

18. The method of claim 14, wherein step (2) is at least partially done by the investigating officer during investigation of the new event.

19. A system for assisting analysis and correlation of multiple events involving firearms, comprising:
a database for storing a plurality of event information data and a plurality of firearms examination information data that are correlated to a single event involving a firearm;
an investigating officer input mechanism for adding applicable event information data at least partially based upon input from an investigating officer for a plurality of events to the database;
a firearms examiner input mechanism for adding firearms information data at least partially based upon input from a person with firearms examiner training for the plurality of events to the database; and
a mapping component for allowing a user of the system to generate a query map that correlates data in the database with a preselected geographic grid based upon one or more preselected matching criteria and at least one data entry for a selected event.

20. The system of claim 19, wherein the system is further comprised of:
a report generating component for generating a report based at least in part upon one or more of the plurality of firearms examination information.
